(19) United States
(12) Patent Application Publication
(10) Pub. No.: US 2008/0166971 A1
(43) Pub. Date: Jul. 10, 2008

(54) Communication Environment Learning Apparatus and Communication Environment Learning Method

(75) Inventors: Kenji Yashiro, Saitama (JP); Kazushi Tahara, Saitama (JP); Tadashi Suzuki, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/885,962

(22) PCT Filed: Mar. 10, 2006
(86) PCT No.: PCT/JP2006/304780

§ 371 Date: Sep. 10, 2007

(30) Foreign Application Priority Data
Mar. 10, 2005 (JP) 2005-067439

(51) Int. Cl. H04Q 7/26; H04B 7/00; H04Q 7/38

(52) U.S. Cl. 455/66.1

(57) ABSTRACT

Position detection means (11), time detection means (12), weather detection means (13), and transmission rate detection means (14) detect the current position, the current time, the weather, and the valid data transmission rate of a mobile reception device (3). According to the detection results, communication environment information is generated. The communication environment information is used for prediction or recognition of the communication condition between the transmission device and the mobile reception device.

### TECHNICAL FIELD

The present invention relates to a communication environment learning apparatus for and a communication environment learning method of learning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system in which two-way communication is made between the transmitting apparatus and the mobile receiving apparatus, in which information is transferred from the receiving apparatus to the mobile receiving apparatus, and in which the information can be reproduced on the mobile receiving device.

### BACKGROUND ART

Nowadays, AV (Audio Visual) equipment and network appliances which have a function of accessing a communication network, such as the Internet, to make information communication are under development. For example, the development of an audio video recorder or the like with the information communication function has been promoted. On the other hand, there has been the spread of mobile terminals which have a function of accessing a communication network for mobile communication, such as a mobile phone network, IMT-2000 (International Mobile Telecommunication 2000), a PHS (Personal Handyphone System), and a wireless LAN (Local Area Network), to make information communication. For example, a mobile phone, a PDA (Personal Digital Assistance), a car navigation apparatus, a mobile personal computer and the like have been widely spread.

As described above, while the mobile terminals have been widely spread and the AV equipment or the like with the information communication function has been developed, the development of a remote playback technology has been promoted. The remote playback technology is generally such a technology that wireless communication is made between a transmitting apparatus such as the AV equipment and a mobile receiving apparatus such as the mobile terminal, that content data such as music and a movie or other data is transmitted to the mobile receiving apparatus from the transmitting apparatus, and that this information is reproduced on the mobile receiving device.

According to the remote playback technology, a user can easily listen to music or watch a movie outside. For example, a user stores an enormous size of content data, such as a large amount of music, video images, and a long movie, on an Audio/Video recorder which is left at home. Then, the user goes outside carrying a mobile terminal, remotely operates the Audio/Video recorder, which is left at home, by using the mobile terminal to thereby transfer the music or movie stored on the Audio/Video recorder to the mobile terminal, and reproduces them on the mobile terminal. This allows the user to easily listen to music or watch the movie outside. In addition, if using a streaming reproduction technology, the user can watch the long movie outside by using the mobile terminal even if a buffer memory of the mobile terminal has a small capacity.

### DISCLOSURE OF INVENTION

### Subject to be Solved by the Invention

By the way, the remote playback is expected to be performed while the mobile terminal is moving. For example, a user may reproduce or play music or a movie with the mobile terminal while moving by train, by bus, in a car the user's friend is driving, or the like. If the mobile terminal moves, the geographical features around the mobile terminal change every second. With this change, the communication environment between the mobile terminal and the AV equipment changes every second. For example, it is assumed that a bus the user takes is driving on an open road on the ground with a good view at one moment, but at a next moment, the bus enters a tunnel. This suddenly makes the communication environment bad around the mobile terminal. If the communication environment becomes bad, the communication between the mobile terminal and the AV equipment does not go well, so that there is a possibility that the music or movie reproduction becomes unstable or impossible. For example, in the case of music, jumpiness possibly occurs, and in the case of video images, the video images are possibly distorted, or a part of the video images is possibly lost.

In view of the problems exemplified above, it is therefore a first object of the present invention to provide a communication environment learning apparatus, a communication environment learning method, and a computer program, which allow accurate prediction or recognition of a communication status between the transmitting apparatus and the mobile receiving apparatus and which allow data transmission control according to a change in the communication environment between the transmitting apparatus and the mobile receiving apparatus in the remote playback.

It is a second object of the present invention to provide a communication environment learning apparatus, a communication environment learning method, and a computer program, which can generate information which highly accurately indicates a good or bad communication environment.

It is a third object of the present invention to provide a communication environment learning apparatus, a communication environment learning method, and a computer program, which can efficiently generate information regarding the communication environment.

### Means for Solving the Subject

The above object of the present invention can be achieved by a communication environment learning apparatus for leaning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system in which two-way communication is made between the transmitting apparatus and the mobile receiving apparatus which are wirelessly connected, in which data is transferred from the transmitting apparatus to the mobile receiving apparatus, and in which the data is reproduced on the mobile receiving device, the communication environment learning apparatus provided with: a position detecting device for detecting a current position of the mobile receiving apparatus and providing position information which indicates the current position; a transmission rate detecting device for detecting an effective data transmission rate which indicates a data amount per unit time which is effectively transmitted from the transmitting apparatus to the mobile receiving apparatus and providing effective data transmission rate information which indicates the effective data transmission rate; a communication environment information generating device for associating the position information with the effective data transmission rate information, to thereby generate communication environment information which indicates (a) a position, (b) an effective data transmission rate at the position, and (c) a correspondence relationship among these; and a recording device for recording the communication environment information onto a recording medium.

The above object of the present invention can be also achieved by a communication environment learning method of leaning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system in which two-way communication is made between the transmitting apparatus and the mobile receiving apparatus which are wirelessly connected, in which data is transferred from the transmitting apparatus to the mobile receiving apparatus, and in which the data is reproduced on the mobile receiving device, the communication environment learning method provided with: a position detecting process of detecting a current position of the mobile receiving apparatus and providing position information which indicates the current position; a transmission rate detecting process of detecting an effective data transmission rate which indicates a data amount per unit time which is effectively transmitted from the transmitting apparatus to the mobile receiving apparatus and providing effective data transmission rate information which indicates the effective data transmission rate; a communication environment information generating process of associating the position information with the effective data transmission rate information, to thereby generate communication environment information which indicates (a) a position, (b) an effective data transmission rate at the position, and (c) a correspondence relationship among these; and a recording process of recording the communication environment information onto a recording medium.

The above object of the present invention can be achieved by a computer program making a computer function as the communication environment learning apparatus of the present invention (including its various aspects).

The above object of the present invention can be also achieved by a computer program product in a computer-readable medium for tangibly embodying a program of instructions executable by a computer, the computer program product making the computer function as the communication environment learning apparatus of the present invention (including its various aspects).

According to the computer program product of the present invention, the aforementioned communication environment learning apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communicating device. More specifically, the computer program product may include computer readable codes to cause the computer (or may comprise computer readable instructions for causing the computer) to function as communication environment learning apparatus of the present invention.

These effects and other advantages of the present invention will become more apparent from the embodiments explained below.

### BRIEF DESCRIPTION OF DRAWINGS

FIG. 1 is a block diagram showing a remote playback system provided with an embodiment of the communication environment learning apparatus of the present invention.

FIG. 2 is a block diagram showing one example of a mobile receiving apparatus provided with the embodiment of the communication environment learning apparatus of the present invention.

FIG. 3 is a block diagram showing one example of a transmitting apparatus.

FIG. 4 is an explanatory diagram showing communication environment information.

FIG. 5 is an explanatory diagram showing enlarged one portion of the communication environment information.

FIG. 6 is an explanatory diagram showing an use example of the communication environment information.

FIG. 7 is a flowchart showing the operation of communication environment learning.

FIG. 8 is a block diagram showing another embodiment of a mobile receiving apparatus provided with another embodiment of the communication environment learning apparatus of the present invention.

FIG. 9 is a block diagram showing another embodiment of a transmitting apparatus provided with another embodiment of the communication environment learning apparatus of the present invention.

### DESCRIPTION OF REFERENCE CODES

1 remote playback system
2, 6 transmitting apparatus
3, 7 mobile receiving apparatus
10, 60A, 60B communication environment learning section (or communication environment learning apparatus)
50 communication environment information

### BEST MODE FOR CARRYING OUT THE INVENTION

Hereinafter, the best mode for carrying out the present invention will be explained in each embodiment in order with reference to the drawings. Firstly, as background knowledge to understand the communication environment learning apparatus of the present invention, an outline of a remote playback system which uses the communication environment learning apparatus will be explained. Then an embodiment of the communication environment learning apparatus of the present invention will be explained. Then, out of the remote playback system, a portion other than the embodiment of the communication environment learning apparatus of the present invention will be explained. After that, another embodiment of the communication environment learning apparatus of the present invention will be explained. Lastly, an embodiment of the communication environment learning method of the present invention will be explained.

(Remote Playback System)

The communication environment learning apparatus of the present invention is an apparatus for leaning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system. As described above, the communication environment learning apparatus of the present invention is used in the remote playback system.

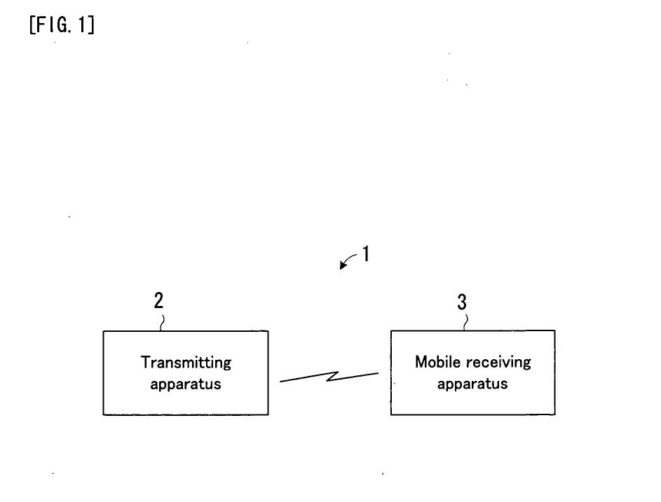

FIG. 1 shows one example of the remote playback system. As shown in FIG. 1, a remote playback system 1 is provided with a transmitting apparatus 2 and a mobile receiving apparatus 3. The transmitting apparatus 2 and the mobile receiving apparatus 3 are wirelessly connected. In the remote playback system 1, the transmitting apparatus 2 and the mobile receiving apparatus 3 make two-way communication with each other. The transmitting apparatus 2 transmits content data to the mobile receiving apparatus 3. The mobile receiving apparatus 3 receives the content data and reproduces it. The content data is digital data, such as music, video images, documents, and the like. Moreover, in the remote playback system 1, the mobile receiving apparatus 3 can transmit the content data to the transmitting apparatus 2. For example, if the mobile receiving apparatus 3 has a video recording function, the mobile receiving apparatus 3 can transmit video data, which is recorded on the mobile receiving apparatus 3, to the transmitting apparatus 2.

A wireless line connected between the transmitting apparatus 2 and the mobile receiving apparatus 3 is, for example, a mobile phone line, IMT-2000, a PHS, a wireless LAN, or the like. Incidentally, all of the communication line between the transmitting apparatus 2 and the mobile receiving apparatus 3 is not necessarily wireless, but one portion of the communication line may be wired. For example, nowadays, there is spread of communication lines in which the Internet network and mobile phone networks are connected through connecting apparatuses, such as mobile internet servers. Such a communication line in which wired and wireless connections are mixed may be used as the communication line between the transmitting apparatus 2 and the mobile receiving apparatus 3. If such a communication line is used, the transmitting apparatus 2 accesses the Internet network through e.g. a fixed phone line (wired) or the like.

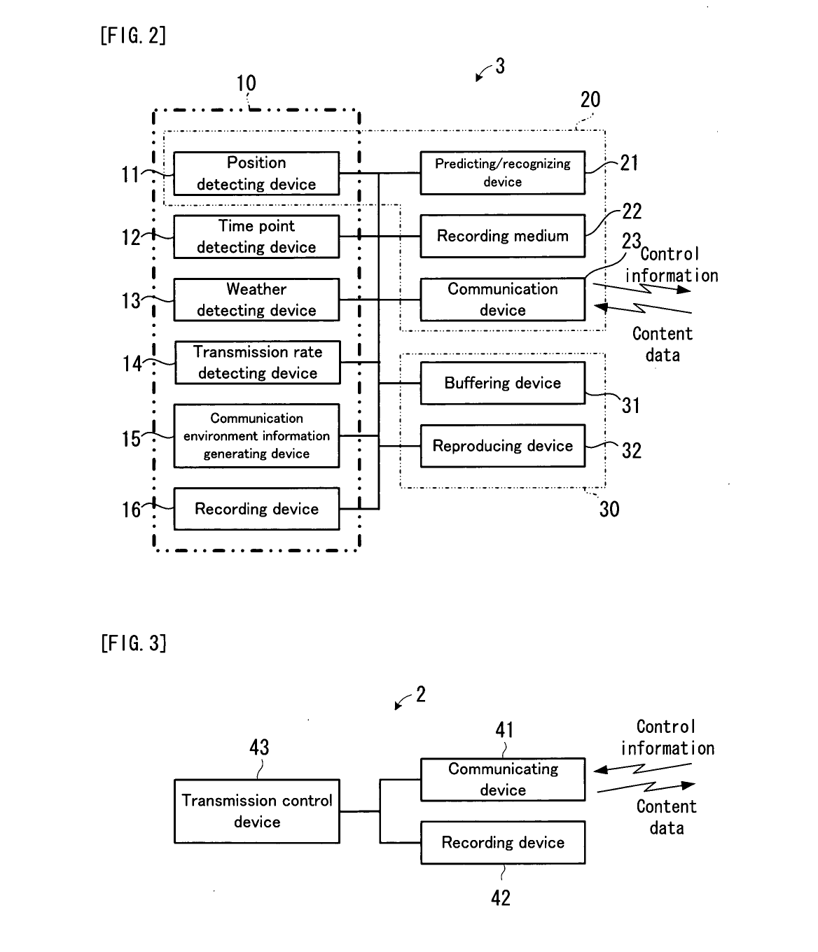

FIG. 2 shows one example of the mobile receiving apparatus 3. The mobile receiving apparatus 3 has functions of making wireless or partially wired communication with the transmitting apparatus 2 or other external equipment, receiving the content data from the mobile receiving apparatus 3, and reproducing the content data. The mobile receiving apparatus 3 is, for example, a mobile phone, a PDA, a car navigation apparatus, a mobile personal computer, or the like, which has an information reproduction function. The mobile receiving apparatus 3 is an apparatus which is excellent in portability and transportability and which is expected to move outside. The mobile receiving apparatus 3, however, is not necessarily an apparatus a user directly carries. It may be an apparatus which is mounted on a car or the like and which is expected to move with the car, as in the car navigation apparatus. Moreover, the mobile receiving apparatus 3 may be a traffic control computer which is mounted on a bus, another transportation vehicle, an airplane, and a ship. Alternatively, it may be a medical-use computer which is mounted on an ambulance.

As shown in FIG. 2, elements (or devices) which constitute the mobile receiving apparatus 3 can be divided into three sections depending on their roles; namely, the three sections are: a communication environment learning section 10; a transmission control section 20; and a content reproduction section 30. The communication environment learning section 10 is an embodiment of the communication environment learning apparatus of the present invention. The communication environment learning section 10 plays a role in learning the communication environment between the transmitting apparatus 2 and the mobile receiving apparatus 3. The transmission control section 20 plays a role in predicting or recognizing a communication status between the transmitting apparatus 2 and the mobile receiving apparatus 3 and transmitting control information, which is necessary to control the transmission of the content data, in accordance with the predicted or recognized communication status. When the transmission control section 20 predicts or recognizes the communication status between the transmitting apparatus 2 and the mobile receiving apparatus 3, what is used is information about the communication environment (i.e. communication environment information) which is learnt on the communication environment learning section 10. On the other hand, the content reproduction section 30 plays a role in reproducing the content data which is transmitted from the transmitting apparatus 2. The communication environment learning section 10, the transmission control section 20, and the content reproduction section 30 will be described in detail later.

FIG. 3 shows one example of the transmitting apparatus 2. The transmitting apparatus 2 has functions of making wireless or partially wired communication with the mobile receiving apparatus 3 or other external equipment and transmitting the content data to the mobile receiving apparatus 3 in order to reproduce the content data on the mobile receiving apparatus 3. The transmitting apparatus 2 is desirably provided with a recording medium with a recording capacity which is large enough to store an enormous size of content data, such as a large amount of music, video images, and a long movie. The transmitting apparatus 2 is, for example, AV equipment, a network appliance (or information appliance), or the like, which has a function of communication with external equipment. The AV equipment is, for example, an information recording/reproducing apparatus, and more specifically a DVD recorder or the like. Moreover, the transmitting apparatus 2 may be a home-use personal computer which functions as the information recording/reproducing apparatus. The transmitting apparatus 2 is an apparatus which does not have portability or transportability and which is left indoors. The transmitting apparatus 2, however, may be an apparatus which has portability or transportability and which can be carried outside if it is provided with a recording medium with a recording capacity which is large enough to store an enormous size of content data, such as a high-performance laptop personal computer, and if it has a function of transmitting the content data to the mobile receiving apparatus 3.

The transmitting apparatus 2 controls the transmission of the content data, on the basis of the control information which is transmitted from the transmission control section 20 of the mobile receiving apparatus 3. For example, if it is predicted or recognized on the transmission control section 20 that the communication status between the transmitting apparatus 2 and the mobile receiving apparatus 3 is good, the transmitting apparatus 2 increases a frame rate of video data which is to be transmitted to the mobile receiving apparatus 3, or reduces a compression rate (e.g. a coding rate), to thereby increase the amount of the video data which is contained in one packet and increase a packet size. By this, high-quality video images can be reproduced on the mobile receiving apparatus 3. On the other hand, if it is predicted or recognized that the communication status is bad, the transmitting apparatus 2 reduces the frame rate of video data which is to be transmitted to the mobile receiving apparatus 3, or increase the compression rate, to thereby reduce the amount of the video data which is contained in one packet and reduce the packet size. By this, the transmission of the data can be kept good between the transmitting apparatus 2 and the mobile receiving apparatus 3, and the reproduction of the video images can be stabilized on the mobile receiving apparatus 3. Moreover, if it is predicted that the communication status will become bad in a few minutes, the transmitting apparatus 2 increases the number of packets which are transmitted per unit time for the few minutes, to thereby increase the amount of the video data per unit time, which is transmitted to the mobile receiving apparatus 3. By this, before the communication status becomes bad, it is possible to store much video data into a buffering device 31 of the mobile receiving apparatus 3. As a result, even after the communication status becomes bad, it is possible to keep stable reproduction for a long time by reproducing the video data which is stored in the buffering device 31.

(Learning Communication Environment)

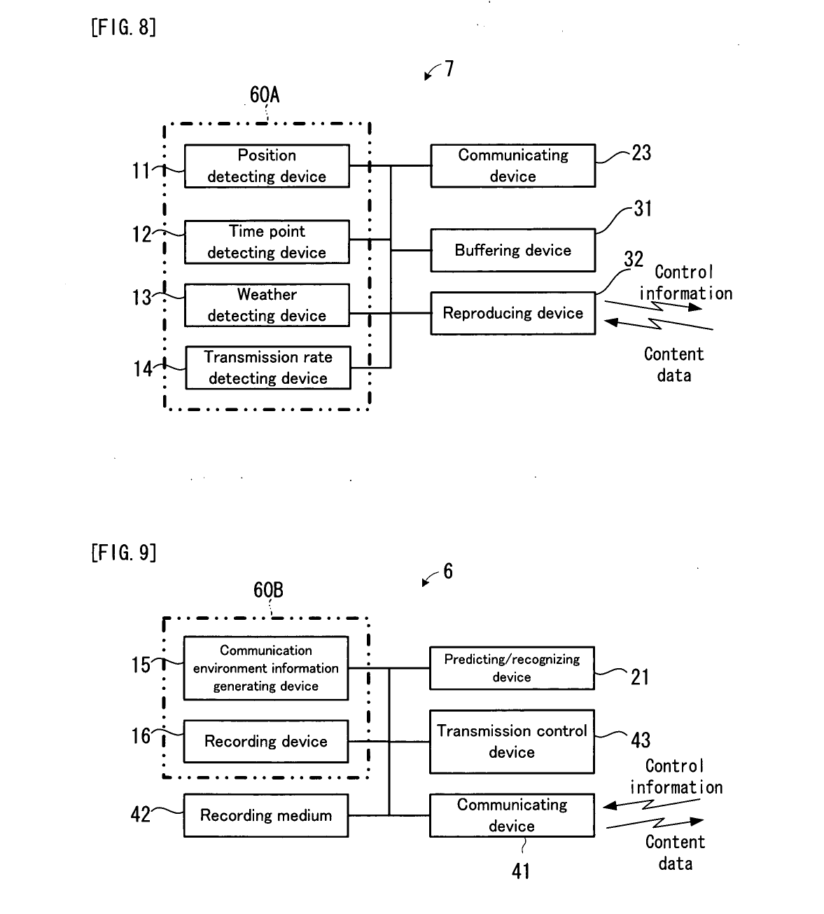

As shown in FIG. 2, the communication environment learning section 10, which is the embodiment of the communication environment leaning apparatus of the present invention, learns the communication environment between the transmitting apparatus 2 and the mobile receiving apparatus 3, in order to control the communication between the transmitting apparatus 2 and the mobile receiving apparatus 3, depending on the communication environment between the transmitting apparatus 2 and the mobile receiving apparatus 3, in the remote playback system 1. Incidentally, in the embodiment, the communication environment leaning apparatus is disposed in the mobile receiving apparatus 3 as the communication environment learning section 10. The present invention, however, is not limited to this. The communication environment leaning apparatus can be also disposed in the transmitting apparatus. Alternatively, the communication environment leaning apparatus can be also divided into two sections, and each of the sections can be disposed in respective one of the transmitting apparatus and the mobile receiving apparatus. An explanation will be given later on the example in which the communication environment leaning apparatus can be also divided into two sections, and in which each of the sections can be disposed in respective one of the transmitting apparatus and the mobile receiving apparatus, by using FIG. 8 and FIG. 9.

As shown in FIG. 2, the communication environment learning section 10 is provided with: a position detecting device 11; a time point detecting device 12; a weather detecting device 13; a transmission rate detecting device 14; a communication environment information generating device 15; and a recording device 16.

The position detecting device 11 detects a current position of the mobile receiving apparatus 3 and provides position information which indicates the current position. The position detecting device 11 is, for example, a GPS (Global Positioning System) receiver. The position information is, for example, a value which indicates the latitude and longitude of the current position of the mobile receiving apparatus 3. For the position detection on the position detecting device 11, for example, a GPS-positioning method or the like can be used.

The time point detecting device 12 detects a current time point of the mobile receiving apparatus 3 and provides time point information which indicates the current time point. The time point detecting device 12 is, for example, a clock. The time point information is, for example, a value which indicates a current month, day, and time point. Incidentally, the “time point” hereinafter means a month, day, and time point. On the other hand, in the case of a “time and minute”, it means only a time and minute, and the month and day are not considered.

The weather detecting device 13 detects the weather at the current position at the time point of the mobile receiving apparatus 3 and provides weather information which indicates the weather. The weather detecting device 13 can access a weather information database through a wireless communication network, by using e.g. a communicating device 23. Moreover, the weather detecting device 13 can receive the weather information which indicates the weather at the current position at the current time point, from the weather information database.

The transmission rate detecting device 14 detects an effective data transmission rate at the current position at the time point of the mobile receiving apparatus 3 and provides effective data transmission rate information which indicates the effective data transmission rate. The effective data transmission rate can be detected by checking the communication operation of the communicating device 23 of the mobile receiving apparatus 3. The transmission rate detecting device 14 can be realized by e.g. an arithmetic processing circuit and a semiconductor memory.

The effective data transmission rate indicates a data amount per unit time which is effectively transmitted from the transmitting apparatus 2 to the mobile receiving apparatus 3. Specifically, the effective data transmission rate (V) is a value obtained by dividing a data amount (A) which is contained in one packet by a time (T) which is spent from when the transmitting apparatus 2 starts the transmission of the one packet data to when the mobile receiving apparatus 3 receives the one packet data without error (V=A/T). Incidentally, the expression that the mobile receiving apparatus 3 receives the one packet data “without error” means that the mobile receiving apparatus 3 can receive the one packet data from the transmitting apparatus 2 and reproduce it.

With regard to the effective data transmission rate, the following can be considered in accordance with a transmission method of transmitting the content data between the transmitting apparatus 2 and the mobile receiving apparatus 3. Firstly, if the content data is streaming-reproduced on the mobile receiving apparatus 3, e.g. UDP/IP (User Datagram Protocol/Internet Protocol) is used as the transmission method between the transmitting apparatus 2 and the mobile receiving apparatus 3. If the content data transmitted from the transmitting apparatus 2 to the mobile receiving apparatus 3 is video data, the video data is contained in each packet. The data amount of each packet is changed by changing the amount of the video data. Changing the data amount of each packet changes the packet size of each packet. The amount of the video data is changed by that the transmitting apparatus 2 changes the frame rate or compression rate of the video data. For example, if it is predicted or recognized that the communication environment is bad between the transmitting apparatus 2 and the mobile receiving apparatus 3, the transmitting apparatus 2 reduces the frame rate of the video data or increases the compression rate of the video data, to thereby reduce the amount of the video data to be transmitted. Then, the transmitting apparatus 2 transmits each packet to the mobile receiving apparatus 3 at a constant transmission rate, i.e. while maintaining the number of packets to be transmitted per unit time. This reduces the data amount of each packet, but this does not change the time which is spent from when the transmitting apparatus 2 starts the transmission of the one packet data to when the mobile receiving apparatus 3 receives the one packet data. Therefore, the effective data transmission rate becomes slow.

Next, on the mobile receiving apparatus 3, if all of the content data is stored into the buffering device 31 and then the content data is reproduced (hereinafter referred to as “reproduction after loading”), e.g. TCP/IP (Transmission Control Protocol/Internet Protocol) is used as the transmission method between the transmitting apparatus 2 and the mobile receiving apparatus 3. In this case, the time which is spent from when the transmitting apparatus 2 starts the transmission of the one packet data to when the mobile receiving apparatus 3 receives the one packet data without error includes a time which is spent the mobile receiving apparatus 3's failing the reception of the one packet data because of an error in the one packet data, the transmitting apparatus 2's retransmitting the one packet data, and the mobile receiving apparatus 3's receiving the packet data without error. This will be explained specifically. If the communication environment is bad between the transmitting apparatus 2 and the mobile receiving apparatus 3, an error tends to be generated in the one packet data which is transmitted from the transmitting apparatus 2. If an error is generated in the one packet data, the mobile receiving apparatus 3 requests the transmitting apparatus 2 to retransmit the packet (or the packet including the same packet). In response to this, the transmitting apparatus 2 retransmits the packet. This prolongs the time which is spend from when the transmitting apparatus 2 starts the transmission of the one packet data to when the mobile receiving apparatus 3 receives the one packet data without error, compared with the case that the one packet data is transmitted and received without error even once (i.e. in the case that the retransmission is not performed). However, since the retransmitted data is the same as the data that is transmitted immediately before, there is no change in the amount of data which is transmitted from the transmitting apparatus 2 to the mobile receiving apparatus 3 and which is reproduced by the mobile receiving apparatus 3 (i.e. the amount of data which is effectively transmitted). Therefore, in this type of case, the effective data transmission rate becomes slow.

The effective data transmission rate is closely related to the communication environment between the transmitting apparatus 2 and the mobile receiving apparatus 3. When the communication environment is good, the effective data transmission rate is fast. For example, in case of the streaming reproduction, if the communication environment is good, even if the data amount per unit time is increased which is transmitted from the transmitting apparatus 2 to the mobile receiving apparatus 3, the data can be transmitted without error. Thus, the transmitting apparatus 2 increases the frame rate of the video data or reduces the compression rate of the video data, to thereby increase the amount of the video data of each packet. As a result, the effective data transmission rate becomes fast. Moreover, in case of the reproduction after loading, if the communication environment is good, an error is hardly generated in the data of each packet, so that the packet data hardly fails to be received on the mobile receiving apparatus 3. Thus, the packet is hardly retransmitted. In fact, if the packet is not retransmitted, the effective data transmission rate becomes fast.

On the other hand, when the communication environment is bad, the effective data transmission rate is slow. For example, in case of the streaming reproduction, when the communication environment is bad, if the data amount per unit time is not reduced which is transmitted from the transmitting apparatus 2 to the mobile receiving apparatus 3, the data is hardly transmitted without error. Thus, the transmitting apparatus 2 reduces the frame rate of the video data or increases the compression rate of the video data, to thereby reduce the amount of the video data of each packet. As a result, the effective data transmission rate becomes slow. Moreover, in case of the reproduction after loading, if the communication environment is bad, an error is easily generated in the data of each packet, so that the packet data easily fails to be received on the mobile receiving apparatus 3. Thus, the packet is easily retransmitted. In fact, if the packet is retransmitted, the effective data transmission rate becomes slow.

The communication environment information generating device 15 associates the position information provided by the position detecting device 11, the time point information provided by the time point detecting device 12, the weather information provided by the weather detecting device 13, and the effective data transmission rate information provided by the transmission rate detecting device 14 with each other, to thereby generate the communication environment information. The communication environment information is information which indicates (a) a position, (b) a time point, (c) weather, (d) an effective data transmission rate at the position, at the time point, and in the weather, and (e) a correspondence relationship among these.

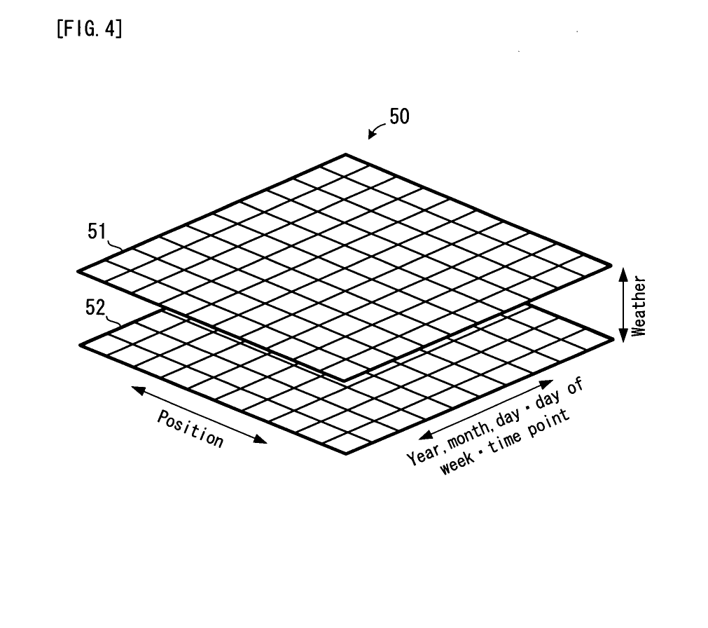

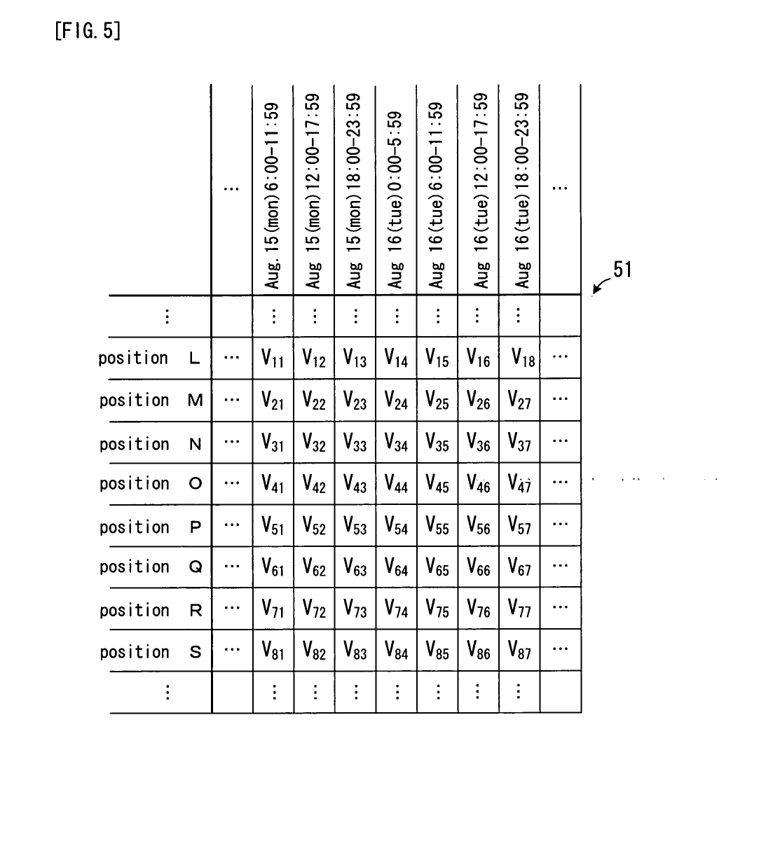

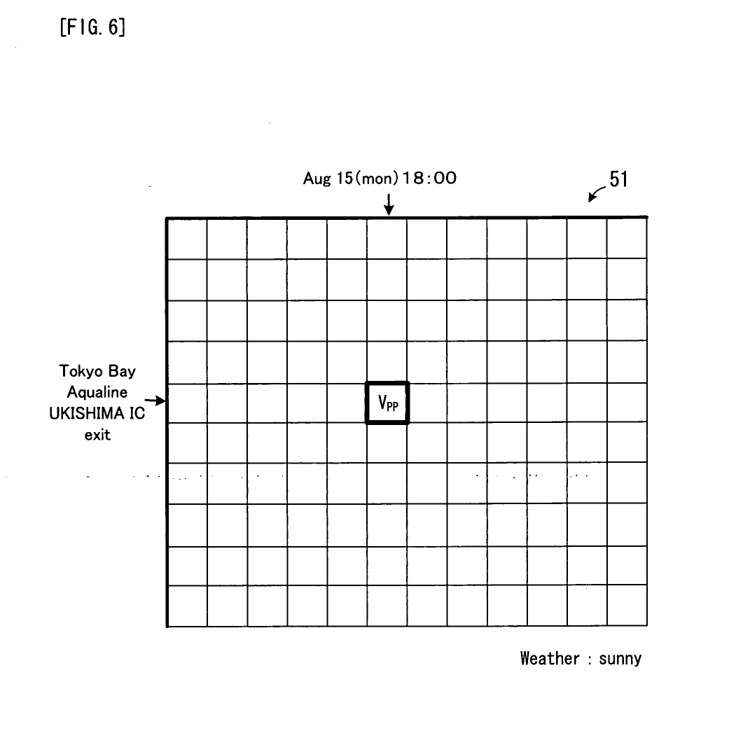

FIG. 4 and FIG. 5 show one example of the communication environment information. As shown in FIG. 4, communication environment information 50 has e.g. two tables 51 and 52. One of the tables 51 describes the correspondence relationship among the position, the time point, and the effective data transmission rate if the weather is sunny or cloudy. The other table 52 describes the correspondence relationship among the position, the time point, and the effective data transmission rate if the weather is rainy or snowy. As shown in FIG. 5, the table 51 describes a plurality of effective data transmission rates Vxy, wherein different positions are assigned to respective rows of the table 51 and different time points are assigned to respective columns. The table 52 has the same structure as that of the table 51. For example, as shown in FIG. 6, it is assumed that the weather is sunny at a current position at a current time point of the mobile receiving apparatus 3, that the current position is a UKISHIMA interchange exit on Tokyo Bay Aqualine, and that the time point is August 15, Monday, 18:00. With refer to the table 51, one effective data transmission rate information Vpp can be read which corresponds to the weather, the position, and the time point.

Incidentally, the communication environment information 50 shown in FIG. 4 has two classifications regarding the weather, for convenience of explanation; however, the present invention is not limited to this. The number of classifications regarding the weather may be increased. Moreover, if it is requested to reduce the data size of the communication environment information, the information may not be classified regarding the weather. Moreover, in the communication environment information 50 shown in FIG. 5, the classification regarding the time point is roughly arranged, like “August 15, Monday, 18:00-23:59”; however, the present invention is not limited to this. The classification regarding the time point may be finely arranged, such as every one hour and every 30 minutes.

Moreover, the communication environment information generating device 15 may be provided with a function of generating second position information. The second position information is generated by modifying the position information (or first position information) which indicates the longitude and latitude of the current position and which is obtained from the position detecting device 11, by using autonomous navigation or map matching or the like. For example, if the mobile receiving apparatus 3 is a car navigation apparatus, the position information can be modified by the autonomous navigation by using a velocity sensor, an angular velocity sensor or the like, which are mounted on a car. Moreover, if map information is recorded on a recording medium 22 of the mobile receiving apparatus 3, the position information can be modified by the map matching. If the communication environment information generating device 15 is provided with the function of generating the second position information, the communication environment information 50 is generated by using the second position information instead of the position information (or first position information). This allows the accuracy of the communication environment information 50 to be improved. Incidentally, FIG. 6 exemplifies the case that the communication environment information 50 is generated by the second position information.

Moreover, the communication environment information generating device 15 may be provided with a function of generating second time point information. The second time point information is generated by adding a value which indicates a current day of the week to a value which indicates a current month, day, and time point (or first time point information), which is obtained from the time point detecting device 12. For example, if calendar information is recorded on the recording medium 22 of the mobile receiving apparatus 3, the current day of the week can be determined on the basis of the current year, month, and day, by referring to the calendar information. If the communication environment information generating device 15 is provided with the function of generating the second time point information, the communication environment information 50 is generated by using the second time point information instead of the time point information (or first time point information). For example, in comparison with Sunday, which is a holiday, and Monday, which is a weekday, it is expected that there are different communication environments even at the same position, at the same time and minute, and in the same weather. Therefore, the accuracy of the communication environment information 50 can be improved by generating the communication environment information 50 by using the second time point information. Incidentally, FIG. 5 and FIG. 6 exemplify the case that the communication environment information 50 is generated by the second time point information.

Moreover, the communication environment information generating device 15 may be provided with a function of generating second effective data transmission rate information. The second effective data transmission rate information is generated by using a statistical method on the basis of the plurality of effective data transmission rate information at the same position, at the same time and minute, and in the same weather (or first effective data transmission rate information), which is obtained from the transmission rate detecting device 14. For example, the average value or mode value of the plurality of effective data transmission rate information at the same position, at the same time and minute, and in the same weather is calculated, and the value obtained by this is regarded as the second effective data transmission rate information. The plurality of effective data transmission rate information at the same position, at the same time and minute, and in the same weather can be obtained, for example, if the mobile receiving apparatus 3 passes through the UKISHIMA interchange exit on Tokyo Bay Aqualine, on August 15 at 18:00 and further on August 16 at 18:00 and if the weather is sunny on the both days. If the communication environment information generating device 15 is provided with the function of generating the second effective data transmission rate information, the communication environment information 50 is generated by using the second effective data transmission rate information instead of the effective data transmission rate information (or first effective data transmission rate information). This allows the accuracy of the communication environment information 50 to be improved.

The recording device 16 records the communication environment information 50 onto the recording medium 22.

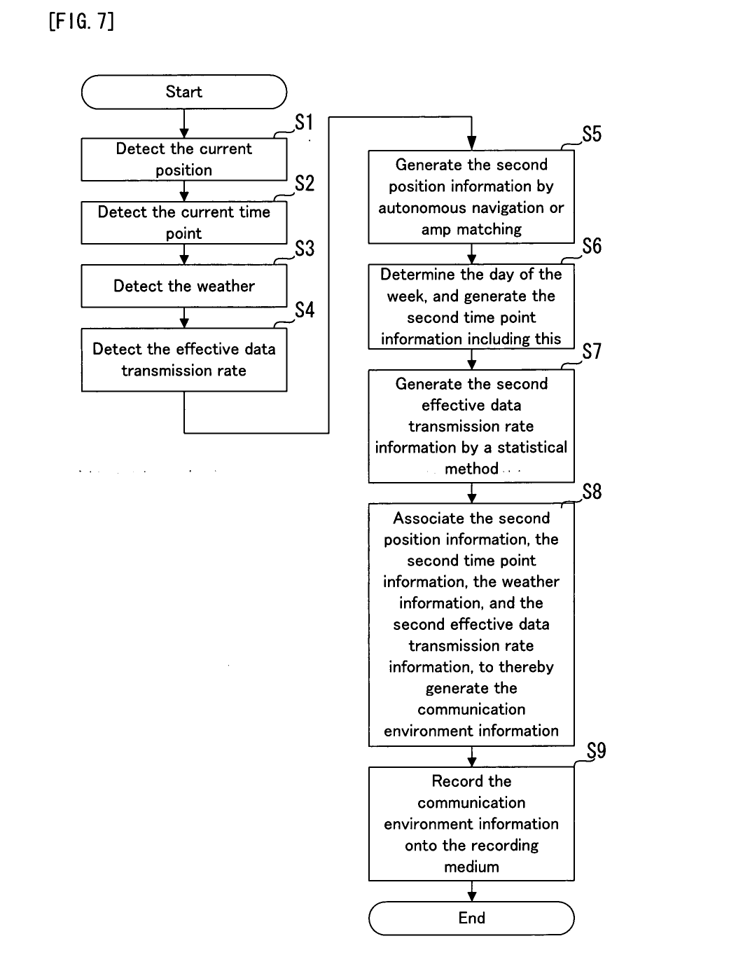

FIG. 7 shows one example of the operation of the communication environment learning section.

As shown in FIG. 7, firstly, the position detecting device 11 detects the current position and provides the position information (step S1). Moreover, the time point detecting device 12 detects the current time point and provides the time point information (step S2). Moreover, the weather detecting device 13 detects the weather and provides the weather information (step S3). Moreover, the transmission rate detecting device 14 detects the effective data transmission rate and provides the effective data transmission rate information (step S4). Then, the communication environment information generating device 15 generates the second position information by modifying the position information by the autonomous navigation or map matching (step S5). Moreover, the communication environment information generating device 15 determines the day of the week on the basis of the time point information by referring to the calendar information and generates the second time point information which indicates the month, and day, day of the week, and time point (step S6). Moreover, the communication environment information generating device 15 generates the second effective data transmission rate information on the basis of the effective data transmission rate information by the statistical method (step S7). Then, the communication environment information generating device 15 associates the second position information, the second time point information, the weather information, and the second effective data transmission rate information with each other, to thereby generate the communication environment information 50 (step S8). Then, the recording device 16 records the communication environment information 50 onto the recording medium 22 (step S9).

If such an operation is always performed while the remote playback system 1 is operated, the communication environment information 50 gradually becomes rich, and in addition, the accuracy of the communication environment information 50 is increased. For example, if the mobile receiving apparatus 3 moves to various places, the communication environment information 50 is generated at various positions. Moreover, if the mobile receiving apparatus 3 moves night and day, the communication environment information 50 is generated at various time points. Moreover, if the mobile receiving apparatus 3 moves in various weather, the communication environment information 50 is generated in the various weather. Moreover, if the mobile receiving apparatus 3 is operated in the same place at the same time many times, the communication environment information 50 gradually becomes accurate and comes to indicate an actual communication environment accurately. As described above, while the remote playback system 1 is operated, the communication environment learning section 10 generates or updates the communication environment information 50 one after another. That is, the communication environment learning section 10 learns the communication environment and makes the communication environment information 50 grow to the richer and more accurate information.

Incidentally, it is optional to provide the time point detecting device 12. It is also optional to provide the weather detecting device 13. For example, if the time point detecting device 12 and the weather detecting device 13 are eliminated, the communication environment information generating device 15 associates the position information provided by the position detecting device 11 with the effective data transmission rate information provided by the transmission rate detecting device 14, to thereby generated the communication environment information. In this case, the communication environment information can be described on one list which associates the position information (or second position information) with the effective data transmission rate information (or second effective data transmission rate information).

As described above, according to the communication environment learning section 10, since it is constructed such that it leans the communication environment, it allows the accurate prediction or recognition of the communication status between the transmitting apparatus 2 and the mobile receiving apparatus 3, and it allows the data transmission control according to a change in the communication environment between the transmitting apparatus 2 and the mobile receiving apparatus 3 in the remote playback system 1. That is, the longer the remote playback system 1 is operated, the further the communication environment is learnt, which makes the communication environment information rich and accurate. This improves the accuracy of the prediction or recognition of the communication environment between the transmitting apparatus 2 and the mobile receiving apparatus 3, and this allows optimum data transmission according to the change in the communication environment between the transmitting apparatus 2 and the mobile receiving apparatus 3. As a result, even if the communication environment becomes bad, the content data can be appropriately transmitted from the transmitting apparatus 2 to the mobile receiving apparatus 3. Thus, it is possible to ensure the stability of the reproduction of the content data on the mobile receiving apparatus 3. Moreover, even if the content data is transmitted from the mobile receiving apparatus 3 to the transmitting apparatus 2, it is possible to realize the appropriate transmission depending on the communication environment.

Moreover, according to the communication environment learning section 10, since it is constructed such that it collects the position information and the effective data transmission rate information of the mobile receiving apparatus 3 to thereby generate the communication environment information 50 on the basis of those information, it is possible to generate the communication environment information 50 which highly accurately indicates the good or bad communication environment. In addition to this, if the communication environment learning section 10 is constructed such that it collects the time point information and generates the communication environment information 50 on the basis of the position information, the time point information, and the effective data transmission rate information, the accuracy of the communication environment information 50 can be further improved. In addition to this, if the communication environment learning section 10 is constructed such that it collects the weather information and generates the communication environment information 50 on the basis of the position information, the time point information, the weather information, and the effective data transmission rate information, the accuracy of the communication environment information 50 can be further improved.

Moreover, according to the communication environment learning section 10, since it is constructed such that it collects the effective data transmission rate information which is closely related to the communication environment in order to generate the communication environment information 50, the information regarding the communication environment can be efficiently collected.

(Data Transmission Control)

Back in FIG. 2, the transmission control section 20 of the mobile receiving apparatus 3 predicts or recognizes the communication status between the transmitting apparatus and the mobile receiving apparatus 3 and transmits the control information which is necessary to control the transmission of the content data depending on the predicted or recognized communication status. The transmission control section 20 is provided with: the position detecting device; a predicting/recognizing device 21; the recording medium 22; and the communicating device 23.

The position detecting device 11 is a constituent element of the communication environment learning section 10, and at the same time, it is a constituent element of the transmission control section 20. The position detecting device 11, as described above, detects the current position of the mobile receiving apparatus 3 and provides the position information which indicates the current position.

The predicting/recognizing device 21 predicts or recognizes the communication status between the transmitting apparatus and the mobile receiving apparatus 3, on the basis of the communication environment information 50. The predicting/recognizing device 21 has three functions; namely, a prediction function, a current-situation recognition function, and a control-information generation function.

The prediction function of the predicting/recognizing device 21 is a function of predicting the communication status at a future position of the mobile receiving apparatus 3. That is, the predicting/recognizing device 21 recognizes the current position of the mobile receiving apparatus 3 from the position information provided by the position detecting device 11. Moreover, the predicting/recognizing device 21 compares the position information about two or more positions, which are sequentially provided by the position detecting device 11, to thereby recognize a moving direction and a moving speed of the mobile receiving apparatus 3. Then, the predicting/recognizing device 21 predicts the future position of the mobile receiving apparatus 3 on the basis of the current position, the moving direction, and the moving speed of the mobile receiving apparatus 3. Then, the predicting/recognizing device 21 refers to the communication environment information 50, to thereby obtain the effective data transmission rate information at the future position of the mobile receiving apparatus 3. As described above, the effective data transmission rate information indicates the good or bad communication environment between the transmitting apparatus 2 and the mobile receiving apparatus 3. Moreover, the good or bad communication status between the transmitting apparatus 2 and the mobile receiving apparatus 3 is determined by the good or bad communication environment. Therefore, obtaining the effective data transmission rate information at the future position of the mobile receiving apparatus 3 means predicting the communication status between the transmitting apparatus 2 and the mobile receiving apparatus 3 at the future position of the mobile receiving apparatus 3.

The current-situation recognition function of the predicting/recognizing device 21 is a function of recognizing the current status at the current position of the mobile receiving apparatus 3. That is, there is a possible case that although the communication status is predicted between the transmitting apparatus 2 and the mobile receiving apparatus 3 and the frame rate or compression rate of the content data is set on the basis of the prediction, the transmission of the content data does not go well because the communication environment is bad, contrary to expectation. In this case, the predicting/recognizing device 21 detects the fact that the transmission of the content data does not go well and recognizes that the communication environment is bad, contrary to expectation, on the basis of the fact. This will be explained more specifically. In case of the streaming reproduction using UDP/IP, if a packet is discarded because the communication environment is bad, contrary to expectation, the predicting/recognizing device 21 detects the fact and recognizes that the communication environment is bad, contrary to expectation. Moreover, in case of the reproduction after loading using TCP/IP, when a packet is retransmitted because the communication environment is bad, contrary to expectation, the predicting/recognizing device 21 detects the fact and recognizes that the communication environment is bad, contrary to expectation.

The control-information generation function of the predicting/recognizing device 21 is a function of generation the control information which includes a command which is given to the transmitting apparatus 2 to set or change a future or current transmission rate of the content data. The command includes (i) a command to set the transmission rate of the future content data so as to be the data transmission rate indicated by the effective data transmission rate which is obtained from the communication environment information 50 by the prediction function, (ii) a command to reduce the transmission rate of the current content data on the basis of the bad communication environment which is recognized by the recognition function, (ii) a command to increase the transmission rate of the current content data in order to increase the amount that the content data is stored in advance in the buffering device 31 of the mobile receiving apparatus 3, in case the communication environment becomes bad in the future, and the like.

The recording medium 22 is desirably a large-capacity rewritable recording medium which is suitable for long-term storage of data. On the recording medium 22, the communication environment information 50, the map information, the calendar information or the like are recorded.

The communicating device 23 mainly transmits the control information from the mobile receiving apparatus 3 to the transmitting apparatus 2, and receives the content data which is transmitted from the transmitting apparatus 2 to the mobile receiving apparatus 3.

On the other hand, as shown in FIG. 3, the transmitting apparatus 2 is provided with: a communicating device 41; a recording medium 42; and a transmission control device 43. The communicating device 41 mainly receives the control information which is transmitted from the mobile receiving apparatus 3 to the transmitting apparatus 2, and transmits the content data from the transmitting apparatus 2 to the mobile receiving apparatus 3. The recording medium 42 is a recording medium for recording and storing the contented data thereon, and it is desirably a large-capacity recording medium, such as a hard disk and a DVD. The transmission control device 43 sets the transmission rate of the content data when the content data recorded on the recording medium 42 is transmitted from the communicating device 41 to the mobile receiving apparatus 3. Specifically, the transmission control device 43 receives the control information transmitted from the mobile receiving apparatus 3, through the communicating device 41. Then, the transmission control device 43 sets or changes the transmission rate of the content data on the basis of the control information. If the content data to be transmitted is video data, the transmission control device 43 increases the frame rate of the content data or reduces the compression rate when the transmission rate of the content data is increased. On the other hand, the transmission control device 43 reduces the frame rate of the content data or increases the compression rate when the transmission rate of the content data is reduced. Moreover, in case of the reproduction after loading, or if a large amount of content data is stored into the burring device 31 of the mobile receiving apparatus before the reproduction in the streaming reproduction, the transmission control device 43 may change the transmission rate of the content data by increasing or reducing the number of packets which are transmitted per unit time.

(Data Reproduction)

As shown in FIG. 2, the content reproduction section 30 of the mobile receiving apparatus 3 reduces the content data which is transmitted from the transmitting apparatus 2. The content reproduction section 30 is provided with the buffering device 31 and a reproducing device 32. The buffering device 31 is a buffer memory for temporarily storing thereon the content data which is transmitted from the transmitting apparatus 2 and which is received through the communicating device 23. The reproducing device 32 decodes and reproduces the content data which is stored in the buffering device 31. The reproduced content data is outputted to a monitor and a speaker (both of which are not illustrated) which are mounted on the mobile receiving apparatus 3.

### OTHER EMBODIMENTS

FIG. 8 and FIG. 9 show other embodiments of the communication environment learning apparatus. The embodiment of the communication environment learning apparatus shown in FIG. 2 is the communication environment learning section 10 which is mounted on the mobile receiving apparatus 3. In contrast, the communication environment learning apparatus shown in FIG. 8 and FIG. 9 is provided with a communication environment learning section 60A which is mounted on a mobile receiving apparatus 7 and a communication environment learning section 60B which is mounted on a transmitting apparatus 6. As described above, whether each constituent element that constitutes the communication environment learning apparatus is disposed on the mobile receiving apparatus 3 or the transmitting apparatus 2 can be selected, as occasion demands. For example, in the embodiment in FIG. 8 and FIG. 9, the position detecting device 11, the time point detecting device 12, the weather detecting device 13, and the transmission rate detecting device 14 are constituent elements for detecting information which is closely related to the movement of the mobile receiving apparatus 7. Thus, it is convenient to dispose them on the mobile receiving apparatus 7. In contrast, the communication environment information generating device 15 and the recording device 16 are constituent elements which are directly related to the generation of the communication environment information, and the communication environment information is used on the predicting/recognizing device 21. Thus, it is convenient to dispose them near the predicting/recognizing device 21. In the example shown in FIG. 9, the predicting/recognizing device 21 is disposed on the transmitting apparatus 6. Thus, it is convenient to dispose the communication environment information generating device 15 and the recording device 16 on the transmitting apparatus 6.

(Communication Environment Learning Method)

Hereinafter, an embodiment of the communication environment learning method of the present invention will be explained. The embodiment of the communication environment learning method of the present invention is a communication environment learning method of leaning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system in which two-way communication is made between the transmitting apparatus and the mobile receiving apparatus which are wirelessly connected, in which data is transferred from the transmitting apparatus to the mobile receiving apparatus, and in which the data is reproduced on the mobile receiving device. The communication environment learning method is provided with: a position detecting process of detecting a current position of the mobile receiving apparatus and providing position information which indicates the current position (refer to the step S1 in FIG. 7); time point detecting process of detecting a current time point of the mobile receiving apparatus and providing time point information which indicates the current time point (step S2); weather detecting process of detecting weather at the current time position and a current time point of the mobile receiving apparatus and providing weather information which indicates the weather (step S3); a transmission rate detecting process of detecting an effective data transmission rate which indicates a data amount per unit time which is effectively transmitted from the transmitting apparatus to the mobile receiving apparatus and providing effective data transmission rate information which indicates the effective data transmission rate (step S4); a communication environment information generating process of associating the position information, the time point information, the weather information, and the effective data transmission rate information with each other, to thereby generate communication environment information which indicates (a) a position, (b) a time point, (c) weather, (d) an effective data transmission rate at the position, at the time point, and in the weather, and (d) a correspondence relationship among the above information (step S8); and a recording process of recording the communication environment information onto a recording medium (step S9). Incidentally, it is optional to provide the time point detecting process. It is also optional to provide the weather detecting process.

As described above, according to the communication environment learning method of the present invention, since it is constructed such that it leans the communication environment, it allows the accurate prediction or recognition of the communication status between the transmitting apparatus and the mobile receiving apparatus, and it allows the data transmission control according to a change in the communication environment between the transmitting apparatus and the mobile receiving apparatus in the remote playback system. Moreover, according to the communication environment learning method, since it is constructed such that it collects the position information and the effective data transmission rate information of the mobile receiving apparatus to thereby generate the communication environment information on the basis of those information, it is possible to generate the communication environment information which highly accurately indicates the good or bad communication environment. In addition to this, if the communication environment learning method is constructed such that it collects the time point information and generates the communication environment information on the basis of the position information, the time point information, and the effective data transmission rate information, the accuracy of the communication environment information can be further improved. In addition to this, if the communication environment learning method is constructed such that it collects the weather information and generates the communication environment information on the basis of the position information, the time point information, the weather information, and the effective data transmission rate information, the accuracy of the communication environment information can be further improved. Moreover, according to the communication environment learning method, since it is constructed such that it collects the effective data transmission rate information which is closely related to the communication environment in order to generate the communication environment information, the information regarding the communication environment can be efficiently collected.

Incidentally, in the present invention, various changes may be made without departing from the essence or spirit of the invention which can be read from the claims and the entire specification. A communication environment learning apparatus, a communication environment learning method, and a computer program, which involve such changes, are also intended to be within the technical scope of the present invention.

### INDUSTRIAL APPLICABILITY

The communication environment learning apparatus and the communication environment learning method according to the present invention can be applied to AV (Audio Visual) equipment and network appliances which have a function of accessing a communication network, such as the Internet, to make information communication. Moreover, they can be applied to mobile terminals which have a function of accessing a communication network for mobile communication, such as a mobile phone network, IMT-2000 (International Mobile Telecommunication 2000), a PHS (Personal Handyphone System), and a wireless LAN (Local Area Network), to make information communication. Moreover, they can be applied to the communication environment learning apparatus or the like which is mounted on various computer equipment for consumer use or for commercial use, or which can be connected to various computer equipment.

1-11. (canceled)

12. A communication environment learning apparatus for learning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system in which two-way communication is made between the transmitting apparatus and the mobile receiving apparatus which are wirelessly connected, in which data is transferred from the transmitting apparatus to the mobile receiving apparatus, and in which the data is reproduced on the mobile receiving device, said communication environment learning apparatus comprising:
a position detecting device for detecting a current position of the mobile receiving apparatus and providing position information which indicates the current position;
a transmission rate detecting device for detecting an effective data transmission rate which indicates a data amount per unit time which is effectively transmitted from the transmitting apparatus to the mobile receiving apparatus and providing effective data transmission rate information which indicates the effective data transmission rate;
a communication environment information generating device for generating second effective data transmission rate information by using a statistical method on the basis of the provided effective data transmission rate information and associating the position information with the generated second effective data transmission rate information, to thereby generate communication environment information which indicates (a) a position, (b) an effective data transmission rate at the position, and (c) a correspondence relationship among these; and
a recording device for recording the communication environment information onto a recording medium.

13. The communication environment learning apparatus according to claim 12, further comprising a time point detecting device for detecting a current time point of the mobile receiving apparatus and providing time point information which indicates the current time point,
said communication environment information generating device associating the time point information with the position information or the generated second effective data transmission rate information, to thereby generate the communication environment information which indicates (a) a position, (b) a time point, (c) an effective data transmission rate at the position at the time point, and (d) a correspondence relationship among these.

14. The communication environment learning apparatus according to claim 12, further comprising a weather detecting device for detecting weather at the current time position and a current time point of the mobile receiving apparatus and providing weather information which indicates the weather,
said communication environment information generating device associating the weather information with the position information or the generated second effective data transmission rate information, to thereby generate the communication environment information which indicates (a) a position, (b) weather, (c) an effective data transmission rate at the position in the weather, and (d) a correspondence relationship among these.

15. The communication environment learning apparatus according to claim 12, wherein the effective data transmission rate is a value obtained by dividing a data amount which is contained in one packet by a time which is spent from when the transmitting apparatus starts the transmission of the one packet data to when the mobile receiving apparatus receives the one packet data without error.

16. The communication environment learning apparatus according to claim 15, wherein the transmitting apparatus changes a packet size, by changing amount of video data which is to be transmitted in a packet.

17. The communication environment learning apparatus according to claim 16, wherein the transmitting apparatus changes the amount of the video data which is to be transmitted in a packet, by changing a frame rate or a compression rate of the video data.

18. The communication environment learning apparatus according to claim 15, wherein the time which is spent from when the transmitting apparatus starts the transmission of the one packet data to when the mobile receiving apparatus receives the one packet data without error includes a time which is spent the mobile receiving apparatus's failing the reception of the one packet data because of an error in the one packet data, the transmitting apparatus's retransmitting the one packet data, and the mobile receiving apparatus's receiving the packet data without error.

19. A communication environment learning method of learning a communication environment between a transmitting apparatus and a mobile receiving apparatus, in order to control a communication between the transmitting apparatus and the mobile receiving apparatus depending on the communication environment between the transmitting apparatus and the mobile receiving apparatus, in a remote playback system in which two-way communication is made between the transmitting apparatus and the mobile receiving apparatus which are wirelessly connected, in which data is transferred from the transmitting apparatus to the mobile receiving apparatus, and in which the data is reproduced on the mobile receiving device, said communication environment learning method comprising:
a position detecting process of detecting a current position of the mobile receiving apparatus and providing position information which indicates the current position;
a transmission rate detecting process of detecting an effective data transmission rate which indicates a data amount per unit time which is effectively transmitted from the transmitting apparatus to the mobile receiving apparatus and providing effective data transmission rate information which indicates the effective data transmission rate;
a communication environment information generating process of generating second effective data transmission rate information by using a statistical method on the basis of the provided effective data transmission rate information and associating the position information with the generated second effective data transmission rate information, to thereby generate communication environment information which indicates (a) a position, (b) an effective data transmission rate at the position, and (c) a correspondence relationship among these; and
a recording process of recording the communication environment information onto a recording medium.

20. The communication environment learning method according to claim 19, further comprising a time point detecting process of detecting a current time point of the mobile receiving apparatus and providing time point information which indicates the current time point,
said communication environment information generating process associating the time point information with the position information or the generated second effective data transmission rate information, to thereby generate the communication environment information which indicates (a) a position, (b) a time point, (c) an effective data transmission rate at the position at the time point, and (d) a correspondence relationship among these.

21. The communication environment learning method according to claim 19, further comprising a weather detecting process of detecting weather at the current time position and a current time point of the mobile receiving apparatus and providing weather information which indicates the weather,
said communication environment information generating process associating the weather information with the position information or the generated second effective data transmission rate information, to thereby generate the communication environment information which indicates (a) a position, (b) weather, (c) an effective data transmission rate at the position in the weather, and (d) a correspondence relationship among these.

22. A computer program making a computer function as the communication environment learning apparatus according to claim 12.

23. The communication environment learning apparatus according to claim 12, wherein the statistical method is calculating an average value or a mode value of a plurality of effective data transmission rate information at a same position, at a same time and minute, and in same weather, to thereby generate the second effective data transmission rate information.

24. The communication environment learning method according to claim 19, wherein the statistical method is calculating an average value or a mode value of a plurality of effective data transmission rate information at a same position, at a same time and minute, and in same weather, to thereby generate the second effective data transmission rate information.
